(19) United States
(12) Patent Application Publication
(10) Pub. No.: US 2025/0308081 A1
(43) Pub. Date: Oct. 2, 2025

(54) METHOD FOR VIRTUAL FITTING, ELECTRONIC DEVICE, AND STORAGE MEDIUM

(71) Applicant: XIAO-I PLUS INC., Wilmington, DE (US)

(72) Inventors: Hui YUAN, Wilmington, DE (US); Weifeng CHEN, Wilmington, DE (US); Tao GU, Wilmington, DE (US); Yuhao XU, Wilmington, DE (US); Jie CHENG, Wilmington, DE (US); Xincheng ZUO, Wilmington, DE (US)

(73) Assignee: XIAO-I PLUS INC., Wilmington, DE (US)

(21) Appl. No.: 18/734,454

(22) Filed: Jun. 5, 2024

(30) Foreign Application Priority Data
Apr. 1, 2024 (CN) 202410392719.8

(51) Int. Cl. G06T 11/00; G06Q 30/0601; G06V 10/26; G06V 10/30; G06V 10/40; G06V 10/77; G06V 10/774; G06V 10/82; G06V 40/10

(52) U.S. Cl. CPC G06T 11/00; G06Q 30/0643; G06V 10/26; G06V 10/30; G06V 10/40; G06V 10/7715; G06V 10/774; G06V 10/82; G06V 40/10; G06T 2210/16

(57) ABSTRACT

A method for virtual fitting includes: obtaining a first person image and a garment image; performing a masking process of garment information on the first person image to obtain a second person image; and inputting the second person image and the garment image into a virtual fitting model obtained by pre-training to obtain a virtual fitting image. A user who performs the virtual fitting only needs to provide a user image, then a garment can be tried on the user, and there is a good result for any posture. It can greatly improve the shopping experience of users and facilitate the operation of sellers.

### CROSS-REFERENCE TO RELATED APPLICATIONS

This application claims priority to Chinese Patent Application No. 202410392719.8, filed on Apr. 1, 2024, which is hereby incorporated by reference in its entirety.

### TECHNICAL FIELD

The present disclosure relates to the field of image processing, and in particular, to a method for virtual fitting, an electronic device, and a storage medium.

### BACKGROUND

With continuous development of Internet technology, an electronic commerce platform gradually becomes a main way for people to choose and purchase garments. However, compared with an offline in-person try-on, people generally only can determine whether garments are suitable by experience, which has become one of important reasons for a large number of returns of online garment purchases. In addition, in order to display their own garments, a large number of electronic commerce sellers also have a strong demand for models to try on, while a cost of inviting models to shoot also has become one of headaches of most small and medium-sized electronic commerce sellers, after all, a volume of a garment sale is directly proportional to a quality of a model shooting.

With a development of computer vision, image processing and artificial intelligence (AI) technology, a research and development of virtual fitting technology greatly alleviates above two problems. Aiming at a pain point of online shopping garments that cannot be tried on personally, virtual fitting can enable a user to change garments without actual undressing, just upload a selfie, select a garment, a one-key garment changing can be realized, and an online shopping efficiency and a shopping experience of a customer are greatly improved. Aiming at a pain point of the cost of model shooting, the seller may use a model shaping module to generate models by describing a skin color, a hair type, a figure, and other appearance details of the models in text (the models are generated by AI, with no portrait right dispute). Using the model generated by the AI to wear garments specified by the seller can greatly reduce a cost of the small and medium-sized electronic commerce sellers.

However, in the existing virtual fitting technology, the fitting effect is not good, and users cannot achieve a more satisfactory shopping experience.

### SUMMARY

The present disclosure provides a method for virtual fitting, an electronic device, and a storage medium, which can improve the fitting effect of various postures, enhance the shopping experience of users, and facilitate the operation of sellers.

According to a first aspect of the present disclosure, a method for virtual fitting is provided. The method includes: obtaining a first person image and a garment image; performing a masking process of garment information on the first person image to obtain a second person image; and inputting the second person image and the garment image into a virtual fitting model obtained by pre-training to obtain a virtual fitting image; where the virtual fitting model is a dual U-Net structure which includes an image encoder, two U-Nets, and an image decoder, and the two U-Nets are respectively used as a garment characterization network and a latent diffusion network; where the two U-Nets have a same network structure that includes one or more down-sampling layers, one or more intermediate layers, and one or more up-sampling layers.

In some embodiments, the inputting the second person image and the garment image into a virtual fitting model obtained by pre-training to obtain a virtual fitting image includes: inputting the garment image into the image encoder to obtain a garment latent feature, and taking the garment latent feature as an input of the garment characterization network; recording a feature of the up-sampling layers, the intermediate layers, and the down-sampling layers when performing a spatial self-attention operation; inputting the second person image into the image encoder to obtain a person latent feature and mask region information, and taking the person latent feature, the mask region information and a random noise obeying Gaussian distribution as an input of the latent diffusion network; respectively concatenating the feature, recorded by the garment characterization network, of the up-sampling layers, the intermediate layers, and the down-sampling layers when performing the spatial self-attention operation with a feature of the up-sampling layers, the intermediate layers, and the down-sampling layers at a corresponding position of the latent diffusion network when performing the spatial self-attention operation in a process of performing iterative denoising, to obtain a concatenated feature, and taking the concatenated feature as a feature of the latent diffusion network at the corresponding position; and inputting a feature output by the latent diffusion network into the image decoder to output the virtual fitting image.

In some embodiments, a training process of the virtual fitting model includes: adding a random noise to a training sample in a diffusion step based on Markov chain, recovering a clean sample from a noise sample in a reverse process, calculating a loss between a real noise and an estimated noise, back propagating and updating a model parameter of the latent diffusion network until convergence, saving the model parameter and taking the model parameter as a model parameter of the garment characterization network.

In some embodiments, the performing a masking process of garment information on the first person image to obtain a second person image includes: inputting the first person image into a pre-trained deep learning image semantic segmentation neural network model for semantic segmentation to obtain a semantic segmented person image, where the semantic segmented person image at least includes an image divided into a human body information region and a garment information region; and performing the mask processing on the garment information region in the semantic segmented person image to obtain the second person image.

In some embodiments, the performing the mask processing on the garment information region in the semantic segmented person image to obtain the second person image includes: obtaining a fitting region of a garment in the garment image and a person in the semantic segmented person image; and taking a union set of the fitting region and the garment information region in the semantic segmented person image as a region that needs to be masked in a person image.

In some embodiments, the obtaining a fitting region of a garment in the garment image and a person in the semantic segmented person image includes: performing a posture recognition on the semantic segmented person image to obtain posture information; segmenting the garment image to obtain a to-be-masked region of the garment; and inputting the to-be-masked region and the posture information into a pre-trained shallow convolutional neural network to determine a mask region, in a human body in the semantic segmented person image, of the garment in the garment image, and taking the mask region as a region that needs to be performed mask processing in the person image.

According to a second aspect of the present disclosure, a method for virtual fitting is provided. The method includes: obtaining virtual fitting images by using the method for virtual fitting according to the first aspect, where the first person image includes a user image, there are at least two garment images, and the virtual fitting images respectively correspond to the garment images; and selecting at least one target virtual fitting image from at least two virtual fitting images for display or recommendation.

According to a third aspect of the present disclosure, an apparatus for virtual fitting is provided. The apparatus includes: an obtaining module, configured to obtain a first person image and a garment image; a garment information masking module, configured to perform a masking process of garment information on the first person image to obtain a second person image; and a virtual fitting image generation module, configured to input the second person image and the garment image into a virtual fitting model obtained by pre-training to obtain a virtual fitting image; where the virtual fitting model is a dual U-Net structure which includes an image encoder, two U-Nets, and an image decoder, and the two U-Nets are respectively used as a garment characterization network and a latent diffusion network; where the two U-Nets have a same network structure that includes one or more down-sampling layers, one or more intermediate layers, and one or more up-sampling layers.

In some embodiments, the virtual fitting image generation module is configured to input the garment image into the image encoder to obtain a garment latent feature, and take the garment latent feature as an input of the garment characterization network; record a feature of the up-sampling layers, the intermediate layers, and the down-sampling layers when performing a spatial self-attention operation; input the second person image into the image encoder to obtain a person latent feature and mask region information, and take the person latent feature, the mask region information and a random noise obeying Gaussian distribution as an input of the latent diffusion network; respectively concatenate the feature, recorded by the garment characterization network, of the up-sampling layers, the intermediate layers, and the down-sampling layers when performing the spatial self-attention operation with a feature of the up-sampling layers, the intermediate layers, and the down-sampling layers at a corresponding position of the latent diffusion network when performing the spatial self-attention operation in a process of performing iterative denoising, to obtain a concatenated feature, and take the concatenated feature as a feature of the latent diffusion network at the corresponding position; and input a feature output by the latent diffusion network into the image decoder to output the virtual fitting image.

In some embodiments, a training process of the virtual fitting model includes: adding a random noise to a training sample in a diffusion step based on Markov chain, recovering a clean sample from a noise sample in a reverse process, calculating a loss between a real noise and an estimated noise, back propagating and updating a model parameter of the latent diffusion network until convergence, saving the model parameter and taking the model parameter as a model parameter of the garment characterization network.

In some embodiments, the garment information masking module is configured to input the first person image into a pre-trained deep learning image semantic segmentation neural network model for semantic segmentation to obtain a semantic segmented person image, where the semantic segmented person image at least includes an image divided into a human body information region and a garment information region; and perform the mask processing on the garment information region in the semantic segmented person image to obtain the second person image.

In some embodiments, the garment information masking module is configured to obtain a fitting region of a garment in the garment image and a person in the semantic segmented person image; and take a union set of the fitting region and the garment information region in the semantic segmented person image as a region that needs to be masked in a person image.

In some embodiments, the garment information masking module is configured to perform a posture recognition on the semantic segmented person image to obtain posture information; segment the garment image to obtain a to-be-masked region of the garment; and input the to-be-masked region and the posture information into a pre-trained shallow convolutional neural network to determine a mask region, in a human body in the semantic segmented person image, of the garment in the garment image, and take the mask region as a region that needs to be performed mask processing in the person image.

According to a fourth aspect of the present disclosure, an apparatus for virtual fitting is provided. The apparatus includes: a virtual fitting image obtaining module, configured to obtain virtual fitting images by using the method for virtual fitting according to the above method for virtual fitting, where the first person image includes a user image, there are at least two garment images, and the virtual fitting images respectively correspond to the garment images; and a selecting module, configured to select at least one target virtual fitting image from at least two virtual fitting images for display or recommendation.

According to a fifth aspect of the present disclosure, an electronic device is provided. The electronic device includes: a memory and a processor, where the memory stores a computer program, the processor implements the method according to the first and/or second aspect when executing the computer program.

According to a sixth aspect of the present disclosure, a computer-readable storage medium is provided. The computer-readable storage medium stores a computer program, where the method according to the first and/or second aspect of the present disclosure is implemented when the computer program is executed.

According to the technical solution provided by the present disclosure, a user who performs the virtual fitting only needs to provide a user image, then a garment can be tried on the in user, and there is a good fitting result for any posture. It can greatly improve the shopping experience of users and facilitate the operation of sellers.

It should be understood that the content described in the summary of the present disclosure is not intended to limit the key or important features of the embodiments of the present disclosure, nor is it intended to limit the scope of the present disclosure. Other features of the present disclosure will become easy to understand through the following description.

### BRIEF DESCRIPTION OF THE DRAWINGS

The above and other features, advantages, and aspects of the embodiments of the present disclosure will become more apparent with reference to the following detailed description when taken in conjunction with the accompanying drawings. The accompanying drawings are used to better understand the solution, and do not constitute a limitation to the present disclosure, and the same or similar reference signs indicate the same or similar elements.

FIG. 1 is a flowchart of a method for virtual fitting according to an embodiment of the present disclosure.

FIG. 2 is a schematic structural diagram of a virtual fitting model in a method for virtual fitting according to an embodiment of the present disclosure.

FIG. 3 is a flowchart of feature concatenating in a method for virtual fitting according to an embodiment of the present disclosure.

FIG. 4 is a flowchart of a method for virtual fitting according to another embodiment of the present disclosure.

FIG. 5 is a block diagram of an apparatus for virtual fitting according to an embodiment of the present disclosure.

FIG. 6 is a block diagram of an apparatus for virtual fitting according to another embodiment of the present disclosure.

FIG. 7 is a block diagram of an exemplary electronic device according to an embodiment of the present disclosure.

### DETAILED DESCRIPTIONS OF THE EMBODIMENTS

In order to make the objectives, technical solutions, and advantages of the present disclosure clearer, the following clearly and completely describes the technical solutions in the embodiments of the present disclosure in conjunction with the accompanying drawings in the embodiments of the present disclosure, apparently, the described embodiments are just a part but not all of the embodiments of the present disclosure. All other embodiments obtained by a person of ordinary skill in the art based on the embodiments of the present disclosure without creative efforts shall fall within the protection scope of the present disclosure.

In addition, the term “and/or” in this specification is merely an association relationship describing associated objects, and indicates that there may be three relationships, for example, A and/or B may indicate that A exists alone, A and B exist simultaneously, and B exists alone. In addition, the character “/” in this specification generally indicates an “or” relationship between the associated objects.

Existing virtual fitting related technologies may be mainly classified into two categories.

The first is to estimate a deformation of a garment according to a posture of a person through a deep learning technology, and then a deformed garment and the person are fitted together by using a generative adversarial network to achieve a fitting effect. Disadvantages of this kind of method are that a resolution of a finally generated picture is usually low, the deformation of the garment cannot generate a corresponding sense of wrinkle, and a light and shadow fusion is poor; in addition, edge details of a fusion of the garment and the person are generally relatively rough, resulting in a lower overall fidelity of an overall fitting effect.

The second is to use an AI generation tool to replace a bottom-model person with a real model or a portrait of a user after a merchant puts a garment on a dummy model or a real person wears the garment and use them as the bottom-model person. Disadvantages of this kind of method are that although a problem of the cost of inviting models to shoot can be relieved to a certain extent, not only a merchant operation is troublesome, only a specified posture shot by the merchant can be changed, but also a fidelity of replacing the bottom-model person with a real user image has a certain difference from the real user image, so that the user cannot achieve a relatively satisfactory shopping experience.

Therefore, there is a need to provide a method for virtual fitting, an electronic device and a storage medium to improve the fitting effect of various postures, enhance the shopping experience of users, and facilitate the operation of sellers.

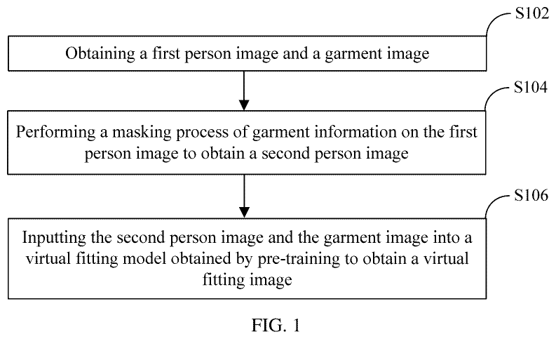

FIG. 1 is a flowchart of a method for virtual fitting 100 according to an embodiment of the present disclosure. As shown in FIG. 1, the method for virtual fitting 100 includes step S102 to step S106.

Step S102, obtaining a first person image and a garment image.

Step S104, performing a masking process of garment information on the first person image to obtain a second person image.

Step S106, inputting the second person image and the garment image into a virtual fitting model obtained by pre-training to obtain a virtual fitting image.

According to the technical solution provided by the present disclosure, a user who performs the virtual fitting only needs to provide a user image, then a garment can be tried on the user, and there is a good fitting result for any posture. It can greatly improve the shopping experience of users and facilitate the operation of sellers.

In step S102, the first person image is an image of a user performing a virtual fitting, where the user is in an original dressing state.

In some embodiments, the first person image and the garment image may be preprocessed to obtain a first person image and a garment image with a predetermined size, such as 512×384 resolution.

In step S104, in some embodiments, the first person image may be input into a pre-trained deep learning image semantic segmentation neural network model for semantic segmentation to obtain a semantic segmented person image. The semantic segmentation is fine-grained segmentation, and in the semantic segmented person image, hair, jackets, trousers, arms, faces, and the like are segmented. The semantic segmented person image at least includes an image divided into a human body information region and a garment information region. The human body information includes a head, a neck, a torso, four limbs, and the like, and the garment information includes a jacket, trousers, a skirt, and the like. The deep learning image semantic segmentation neural network model may be a neural network model such as FCN, U-Net, PSP Net, Mask R-CNN, DeepLab, and the like. The semantic segmentation of the first person image is realized by extracting features of the first person image to obtain a feature map, up-sampling the feature map, and outputting a category of each pixel.

In some embodiments, the masking process is performed on the garment information region in the semantic segmented person image to obtain the second person image, that is, a garment (such as a jacket and trousers) therein is masked according to a garment type corresponding to the semantic segmented person image.

In some embodiments, a fitting region of a garment in the garment image and a person in the semantic segmented person image is obtained. A change of a person posture may cause different deformation of a garment, therefore, a posture recognition is firstly performed on the semantic segmented person image, for example, a posture estimation is performed on the semantic segmented person image by using a deep learning model such as DensePose, OpenPose, and the like; and a garment region distortion and posture alignment are performed according to a recognized posture. The garment image is segmented to obtain a to-be-masked region, that is, a mask. Then, the mask and posture information are input into a pre-trained shallow convolutional neural network, and a mask rough region, in a body of the first person image, of the garment in the garment image is estimated and taken as a region that needs to be masked in a person image. In the shallow convolutional neural network, a feature fusion is performed by using a concat operation.

In some embodiments, a union set of the fitting region and the garment information region in the semantic segmented person image is taken as a region that needs to be masked in the person image.

In order to achieve a better masking effect and a virtual fitting effect, a coverage area of a garment in the first person image needs to be smaller than a coverage area of a garment in the garment image, that is, a fitting position of a new garment contains a position of a garment in the semantic segmented person image, so that a position of the garment in the semantic segmented person image is prevented from being masked but cannot be covered by the new garment.

In some embodiments, in step S106, the virtual fitting model is a dual U-Net structure, which includes an image encoder, two U-Nets, and an image decoder. The two U-Nets are respectively used as a garment characterization network and a latent diffusion network; the two U-Nets have a same network structure that includes one or more down-sampling layers, one or more intermediate layers, and one or more up-sampling layers.

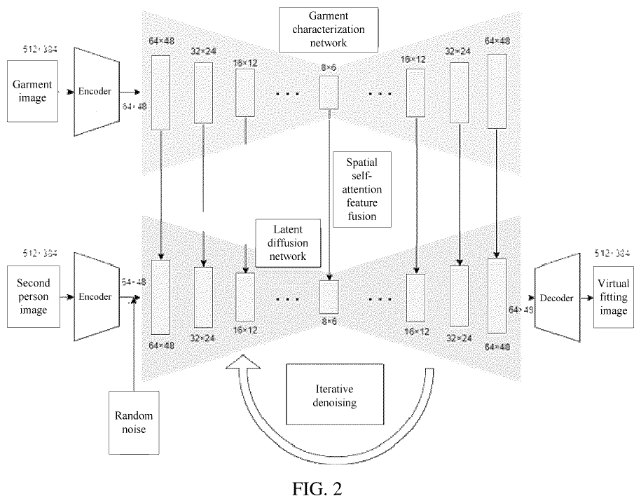

In some embodiments, as shown in FIG. 2, a network structure of the garment characterization network is consistent with a network structure of the latent diffusion network, and an initial parameter of the garment characterization network are a parameter obtained after a training of the latent diffusion network is completed. The U-net includes three down-sampling layers, an intermediate layer, and three up-sampling layers. Each down-sampling layer is a superposition of a convolution module, a space self-attention module, and a down-sampling module (down-sampling twice); the intermediate layer includes a convolution block and a space self-attention block; the up-sampling layer includes a convolution block, a space self-attention module, and an up-sampling layer (up-sampling twice).

In some embodiments, as shown in FIG. 2, a garment image (512×384 resolution) is input into an image encoder to obtain a garment latent feature (64×48), and the garment latent feature is taken as an input of a garment characterization network. Spatial dimensions of operations in the three down-sampling layers are respectively 64×48, 32×24 and 16×12, a spatial dimension of the intermediate layer operation feature is 8×6, and spatial dimensions of operations in the three up-sampling layers are respectively 16×12, 32×24 and 64×48. After the garment characterization network is operated, a feature of the up-sampling layer, the intermediate layer and the down-sampling layer when performing a spatial self-attention operation are recorded.

In some embodiments, after the feature of the up-sampling layer, the intermediate layer and the down-sampling layer when performing a spatial self-attention operation are recorded by the garment characterization network, a person image with a masked garment information (that is, a second person image, 512×384 resolution) is input into the image encoder to obtain a person latent feature (64×48) and mask region information (64×48), and the person latent feature, the mask region information, and a random noise obeying Gaussian distribution are taken as an input of the latent diffusion network. A feature, recorded by the garment characterization network, of the up-sampling layer, the intermediate layer, and the down-sampling layer when performing the spatial self-attention operation and a feature of the up-sampling layer, the intermediate layer, and the down-sampling layer at a corresponding position of the latent diffusion network when performing the spatial self-attention operation in a process of performing iterative denoising is concatenated to be taken as a feature at the corresponding position of the latent diffusion network. A spatial self-attention operation is performed on the concatenated feature, and the garment latent feature is injected into the latent diffusion network at different scales through the spatial self-attention operation, so that a more natural virtual garment changing effect is achieved. The feature (64×48) output by the latent diffusion network is input into an image decoder to output a virtual fitting image (512×384).

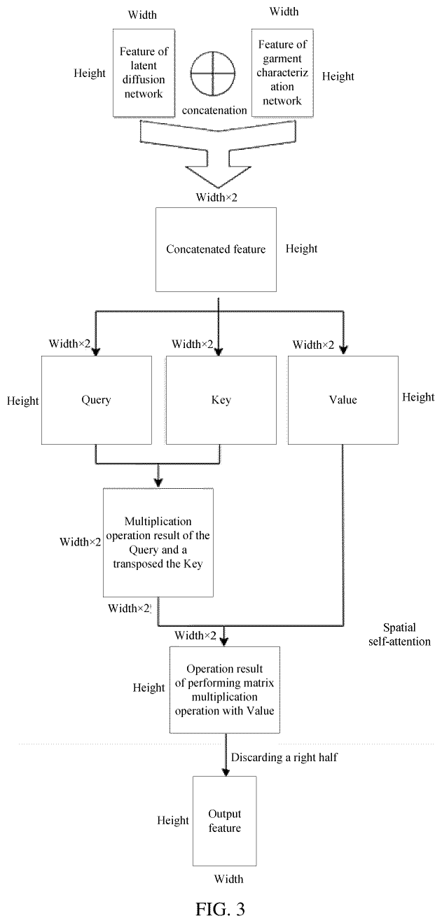

In some embodiments, as shown in FIG. 3, each spatial self-attention module of the latent diffusion network performs feature concatenating by following steps: concatenating a feature (width×height) of the latent diffusion network and a feature (width×height) of the garment characterization network to obtain a concatenated feature ((width×2)×high), where the concatenated feature ((width×2)×height) includes a Query ((width×2)×high), a Key ((width×2)×high) and a Value ((width×2)×high); performing a matrix multiplication operation on the Query ((width×2)×high) and a transpose of the Key ((width×2)×high) to obtain multiplication operation result ((width×2)× (width×2)) of the Query ((width×2)×high) and a transposed the Key ((width×2)×high); performing the matrix multiplication operation on the multiplication operation result ((width×2)× (width×2)) of the Query ((width×2)×high) and the transposed of the Key ((width×2)×height) and the Value ((width×2)×high) to obtain an operation result ((width×2)×high); discarding a right half of the operation result ((width×2)×high), and taking a remaining left half (width×height) as an output feature (width×height). Through above steps, the garment latent feature is injected into the latent diffusion network through the spatial attention operation.

In some embodiments, in order to keep an operation size consistent and a redundant calculation amount is not increased, a feature of a concatenating position is discarded after the spatial self-attention operation is performed.

In some embodiments, in the virtual fitting model, the network structure of the garment characterization network is consistent with the network structure of the latent diffusion network, the initial parameter of the garment characterization network is the parameter obtained after the training of the latent diffusion network is completed, and therefore, the latent diffusion network is first trained. The latent diffusion network defines a diffusion step based on Markov chain, in this step, random (Gaussian) noise is slowly and sequentially added to a sample, and then a clean sample is learned to be recovered from a noise sample during a reverse process. That is, a latent diffusion network estimation is called, a loss between a real noise and an estimated noise is calculated, model parameter of the latent diffusion network is back propagated and updated until convergence, the model parameter is saved and taken as a model parameter of the garment characterization network, and a trained virtual fitting model can be obtained.

In the present disclosure, an advantage of a pre-trained latent diffusion network (LDM) is fully utilized to ensure a high authenticity and a natural try-on effect of a generated image, and a detail feature of the garment in a latent space is further learned through the garment characterization network (garment Unet), then a garment fusion process is performed to accurately align a garment feature with a noisy human body in a self-attention layer of the latent diffusion network (denoising Unet), in this way, the garment feature smoothly adapts to various target human body types and postures without causing information loss or feature distortion due to an independent deformation process. In addition, a garment dropout operation is further performed in the present disclosure, that is, some garment latent variables are randomly discarded in a training process, so as to implement a guidance for the garment feature without a classifier, and through this method, a controllability of garment changing may be further improved.

Specifically, the virtual fitting model is an expansion based on a stable diffusion, and the stable diffusion uses a variational auto-encoder (VAE), which is composed of an encoder E and a decoder D to implement image representation in the latent space. A UNET ϵ_{θ} is trained to remove Gaussian noise ϵ, while encoding a condition input τ_{θ} using a CLIP (Contrastive Language-Image Pretraining) text encoder. Given an image x and a text prompt y, the denoising UNet ϵ_{θ} is trained by minimizing a following loss functions:

$${ℒ}_{LDM} = {E}_{ε ( x ) , y , ϵ ∼ N ( 0 , 1 ) , t} [ {‖ ϵ - {ϵ}_{θ} ( {z}_{t} , t , {τ}_{θ} ( y ) ) ‖}_{2}^{2} ] \qquad Formula ( 1 )$$

where t∈{1, . . . , T} represents a time step of a forward diffusion process, zₜ is an encoded image ε(x) plus Gaussian noise ϵ˜N(0,1) (that is, a noise latent variable), and a condition input τ_{θ}(y) is associated with the denoising UNet through a cross attention mechanism.

The garment UNet is used to efficiently learn detail features of a garment image g, the garment UNet is essentially same as the denoising UNet in the stable diffusion, a coded garment latent variable ε(g) is input into the garment UNet ω_{θ′}, and then is integrated into the denoising UNet ϵ_{θ} through a garment fusion. In addition to an auxiliary condition input, the garment UNet and the denoising UNet are jointly trained by minimizing a following loss functions:

$${ℒ}_{OOTD} = {E}_{ε ( {x}_{m} ) , ε ( g ) , ψ , ϵ ∼ N ( 0 , 1 ) , t} [ {‖ ϵ - {ϵ}_{θ} ( {z}_{t} , t , {ω}_{{θ}^{′}} ( ε ( g ) , ψ ) , ψ ) ‖}_{2}^{2} ] \qquad Formula ( 2 )$$

Where ψ=τ_{g}(g)©τ_{y}(y) represents the auxiliary condition input for the garment UNet We′ and the denoising UNet Ee. While τ_{g} and τ_{y} represent a pre-trained CLIP image encoder and the text encoder respectively, and © denotes concatenation. ω_{θ′} and ϵ_{θ} do not share any weights during the training process. A significant difference between the garment UNet and the denoising UNet is that before multiple denoising steps in an inference process, the garment UNet only needs a one-step forward process, which brings minimal extra calculation cost to an original stable diffusion.

The garment fusion is to integrate a learned garment feature into the denoising UNet, and find each pair of feature maps as an input of a corresponding self-attention layer. Given a n-th pair of feature maps gₙ, xₙ∈ [symbol] ^{c}^{ₙ}^{×h}^{ₙ}^{×w}^{ₙ}, the feature maps are concatenated together in the spatial domain, as shown below:

$${x}_{{g}_{n}} = {x}_{n} © {g}_{n} ∈ {ℝ}^{{c}_{n} \times {h}_{n} \times 2 {w}_{n}} \qquad Formula ( 3 )$$

The concatenated feature map x_{g}_{ₙ} replaces xₙ, and is taken as an input of a denoising UNet self-attention layer, and then a front half of the feature map is cut as a final output of the self-attention layer. In a denoising process, an attention of the human body gradually includes a part of a mask region, such as a neck and an arm, and an attention of the garment feature gradually increases in a region with a complex pattern. Through garment fusion in the self-attention layer, the garment feature is implicitly deformed and effectively associated with a target human body, and almost no information is lost, therefore, the denoising UNet can learn an accurate feature of the garment UNet to retain garment details, and naturally adapt a garment to the target human body in the generated image.

In order to further improve a reliability of the method for the virtual fitting, the garment dropout operation may be used in the training process to implement the guidance without the classifier, thereby adjusting an image generation quality and diversity of the garment feature. Specifically, in the training process of the garment UNet, an inputted garment latent variable is randomly discarded as ε(g)=ϕ, ϕ∈ [symbol] ^{c}^{ₙ}^{×h}^{ₙ}^{×w}^{ₙ} refers to an all-zero latent variable, so that the denoising UNet is trained conditionally or unconditionally, that is, in a case with or without garment fusion. In an inference process, a guide ratio s_{g}≥1 is simply used to adjust a conditional control intensity for a predicted noise \hat{ϵ}_{θ}, as shown below:

$${\hat{ϵ}}_{θ} ( {z}_{t} , {ω}_{{θ}^{′}} ( ε ( g ) ) ) = {ϵ}_{θ} ( {z}_{t} , ϕ ) + {s}_{g} \cdot ( {ϵ}_{θ} ( {z}_{t} , {ω}_{{θ}^{′}} ( ε ( g ) ) ) - {ϵ}_{θ} ( {z}_{t} , ϕ ) ) \qquad Formula ( 4 )$$

For a sake of brevity, some secondary items are omitted compared to formula (2). In a practice, a garment dropout ratio in the training process is set to 10% according to experience, that is, 10% of the garment latent variable ε(g) is set to ϕ, and an optimal value of the guide ratio s_{g} is usually between 1.5 and 2.0.

The following technical effects are implemented according to the embodiments of the present disclosure.

By injecting the garment latent feature into the latent diffusion network, a realism retention and texture consistency exceed a solution based on a generative adversarial network. For example, a balance of keeping a texture of a fitting garment consistent with a texture of a photographed garment and a fitting authenticity is realized, a light and shadow and wrinkle details of a tiled garment is retained, and a satisfactory fitting effect of a user is achieved. A user who performs the virtual fitting only needs to provide a user image, then a garment can be tried on the user, and there is a good result for any posture. It can greatly improve the shopping experience of users and facilitate the operation of sellers.

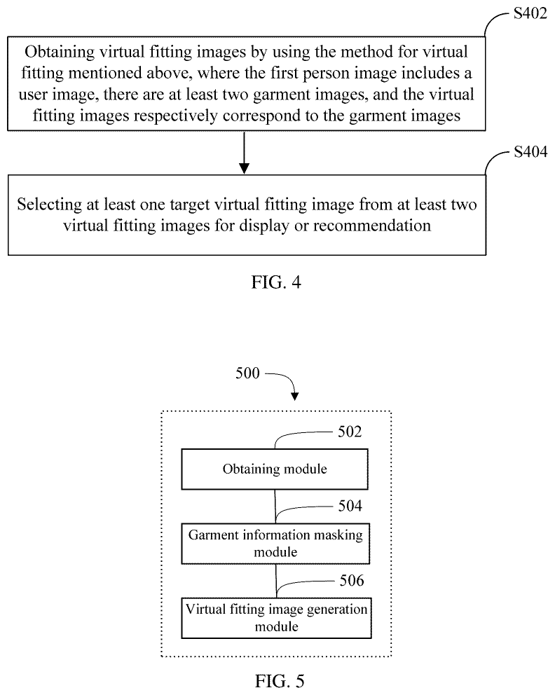

FIG. 4 is a flowchart of a method for virtual fitting 400 according to an embodiment of the present disclosure. As shown in FIG. 4, the method for virtual fitting 400 includes step S402 and step S404.

Step S402, obtaining virtual fitting images by using the method for virtual fitting mentioned above, where the first person image includes a user image, there are at least two garment images, and the virtual fitting images respectively correspond to the garment images.

Step S404, selecting at least one target virtual fitting image from at least two virtual fitting images for display or recommendation.

In some embodiments, an application of the virtual fitting for a user may include two application scenarios. The first application scenario is a user virtual fitting, for example, a user uploads a user image, and a plurality of fitting images are generated for user to select by combining his/her own user image with a plurality of garment images. The second application scenario is a merchant propaganda, for example, a merchant uses a model image to generate a virtual fitting image of their own garment, and a generated image may be displayed and propagandized through a webpage or a large screen of a shopping mall, and the model image may be a photographed model or a generated model.

In some embodiments, a manner of selecting the at least one target virtual fitting image for presentation or recommendation may be that the user manually selects from the plurality of generated fitting images, or may be that a system sorts the generated fitting images according to a generation effect and selects a first few with better results.

It should be noted that, for the foregoing method embodiments, for simple description, all the foregoing method embodiments are expressed as a series of action combinations, but it should be appreciated by those skilled in the art that the present disclosure is not limited by the described action sequence, as some steps may be performed in other orders or simultaneously according to the present disclosure. In addition, those skilled in the art should also understand that the embodiments described in the specification are all optional embodiments, and the involved actions and modules are not necessarily required by the present disclosure.

The above is an introduction of the method embodiment, and the solution of the present disclosure will be further described below through apparatus embodiments.

FIG. 5 is a block diagram of an apparatus for virtual fitting 500 according to an embodiment of the present disclosure, as shown in FIG. 5, the apparatus includes an obtaining module 502, a garment information masking module 504 and a virtual fitting image generation module 506.

The obtaining module 502 is configured to obtain a first person image and a garment image.

The garment information masking module 504 is configured to perform a masking process of garment information on the first person image to obtain a second person image.

The virtual fitting image generation module 506 is configured to input the second person image and the garment image into a virtual fitting model obtained by pre-training to obtain a virtual fitting image. The virtual fitting model is a dual U-Net structure which includes an image encoder, two U-Nets, and an image decoder, the two U-Nets are respectively used as a garment characterization network and a latent diffusion network; and the two U-Nets have a same network structure that includes one or more down-sampling layers, one or more intermediate layers, and one or more up-sampling layers.

According to the technical solution provided by the present disclosure, a user who performs the virtual fitting only needs to provide a user image, then a garment can be tried on the user, and there is a good fitting result for any posture. It can greatly improve the shopping experience of users and facilitate the operation of sellers.

In some embodiments, the virtual fitting image generation module 506 is configured to input the garment image into the image encoder to obtain a garment latent feature, and take the garment latent feature as an input of the garment characterization network; record a feature of the up-sampling layers, the intermediate layers, and the down-sampling layers when performing a spatial self-attention operation; input the second person image into the image encoder to obtain a person latent feature and mask region information, and take the person latent feature, the mask region information and a random noise obeying Gaussian distribution as an input of the latent diffusion network; respectively concatenate the feature, recorded by the garment characterization network, of the up-sampling layers, the intermediate layers, and the down-sampling layers when performing the spatial self-attention operation with a feature of the up-sampling layers, the intermediate layers, and the down-sampling layers at a corresponding position of the latent diffusion network when performing the spatial self-attention operation in a process of performing iterative denoising, to obtain a concatenated feature, and take the concatenated feature as a feature of the latent diffusion network at the corresponding position; and input a feature output by the latent diffusion network into the image decoder to output the virtual fitting image.

In some embodiments, a training process of the virtual fitting model includes: adding a random noise to a training sample in a diffusion step based on Markov chain, recovering a clean sample from a noise sample in a reverse process, calculating a loss between a real noise and an estimated noise, back propagating and updating a model parameter of the latent diffusion network until convergence, saving the model parameter and taking the model parameter as a model parameter of the garment characterization network.

In some embodiments, the garment information masking module 504 is configured to input the first person image into a pre-trained deep learning image semantic segmentation neural network model for semantic segmentation to obtain a semantic segmented person image, where the semantic segmented person image at least includes an image divided into a human body information region and a garment information region; and perform the mask processing on the garment information region in the semantic segmented person image to obtain the second person image.

In some embodiments, the garment information masking module 504 is configured to obtain a fitting region of a garment in the garment image and a person in the semantic segmented person image; and take a union set of the fitting region and the garment information region in the semantic segmented person image as a region that needs to be masked in a person image.

In some embodiments, the garment information masking module 504 is configured to perform a posture recognition on the semantic segmented person image to obtain posture information; segment the garment image to obtain a to-be-masked region of the garment; and input the to-be-masked region and the posture information into a pre-trained shallow convolutional neural network to determine a mask region, in a human body in the semantic segmented person image, of the garment in the garment image, and take the mask region as a region that needs to be performed mask processing in the person image.

For the detailed implementation processes of the function and role of each module in the foregoing apparatus embodiments of FIG. 5, refer to the implementation processes of the corresponding steps in the foregoing method embodiments of FIG. 1, which will not be repeated herein.

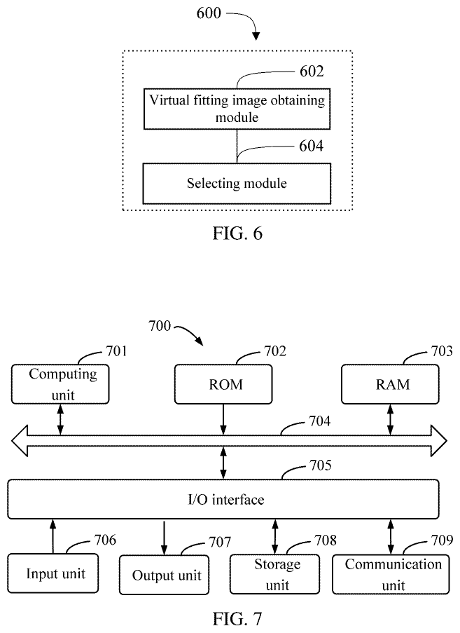

FIG. 6 is a block diagram of an apparatus for virtual fitting 600 according to another embodiment of the present disclosure, as shown in FIG. 6, the apparatus includes a virtual fitting image obtaining module 602 and a selecting module 604.

The virtual fitting image obtaining module 602 is configured to obtain virtual fitting images by using the method for virtual fitting according to the above method for virtual fitting, where the first person image includes a user image, there are at least two garment images, and the virtual fitting images respectively correspond to the garment images.

The selecting module 604 is configured to select at least one target virtual fitting image from at least two virtual fitting images for display or recommendation.

In some embodiments, a manner of selecting the at least one target virtual fitting image for presentation or recommendation may be that the user manually selects from the plurality of generated fitting images, or may be that a system sorts the generated fitting images according to a generation effect and selects a first few with better results.

For the detailed implementation processes of the function and role of each module in the foregoing apparatus embodiments of FIG. 6, refer to the implementation processes of the corresponding steps in the foregoing method embodiments of FIG. 4, which will not be repeated herein.

According to an embodiment of the present disclosure, the present disclosure further provides an electronic device, a readable storage medium, and a computer program product.

FIG. 7 is a schematic block diagram of an electronic device 700 according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile devices, such as a personal digital assistant, a cellular phone, a smart phone, a wearable device, and other similar computing devices. The components, their connections and relationships, and their functions shown herein are merely examples, and are not intended to limit the implementation of the present disclosure described and/or required herein.

The electronic device 700 includes a computing unit 701, which may perform various appropriate actions and processing according to a computer program stored in the ROM 702 or a computer program loaded into the RAM 703 from a storage unit 708. In the RAM 703, various programs and data required for an operation of the electronic device 700 may also be stored. The computing unit 701, the ROM 702, and the RAM 703 are connected to each other through a bus 704. An I/O interface 705 is also connected to the bus 704.

A plurality of components in the electronic device 700 are connected to the I/O interface 705, which includes: an input unit 706, such as a keyboard, a mouse, and the like; an output unit 707, such as various types of displays, speakers, and the like; a storage unit 708, such as a magnetic disk or an optical disk; and a communication unit 709, such as a network card, a modem, a wireless communication transceiver, and the like. The communication unit 709 allows the electronic device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, and the like. The computing unit 701 performs the various methods and processes described above, such as the method 100 or method 400. For example, in some embodiments, the method 100 or method 400 may be implemented as a computer software program tangibly contained in a machine-readable medium, such as the storage unit 708. In some embodiments, part or all of the computer program may be loaded and/or installed on the electronic device 700 via the ROM 702 and/or the communication unit 709. When the computer program is loaded into the RAM 703 and executed by the computing unit 701, one or more steps of the method 100 or method 400 described above may be performed. Alternatively, in other embodiments, the computing unit 701 may be configured to perform the method 100 or method 400 in any other suitable manner (for example, by means of a firmware).

Various implementations of the systems and techniques described above herein may be implemented in a digital electronic circuit system, an integrated circuit system, a field programmable gate array (FPGA), an disclosure specific integrated circuit (ASIC), an disclosure specific standard product (ASSP), a system on chip (SOC), a load programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general-purpose programmable processor, may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program codes may be provided to a processor or a controller of a general-purpose computer, a special-purpose computer, or other programmable data processing apparatus, so that the program codes, when executed by the processor or the controller, cause the functions/operations specified in the flowcharts and/or block diagrams to be implemented. The program code may execute entirely on the machine, partly on the machine, partly on the machine as a stand-alone software package and partly on a remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In order to provide interaction with a user, the systems and techniques described herein may be implemented on a computer having a display device for displaying information to a user, and a keyboard and pointing device (for example, a mouse or trackball) through which the user can provide input to the computer. Other types of devices may also be used to provide interaction with a user; for example, the feedback provided to the user may be any form of sensory feedback (for example, visual feedback, auditory feedback, or tactile feedback); and input from the user may be received in any form (including acoustic input, voice input, or tactile input).

The systems and techniques described herein may be implemented in a computing system (for example, as a data server) that includes a background component, or a computing system (for example, an disclosure server) that includes a middleware component, or a computing system that includes a front-end component (for example, a user computer having a graphical user interface or a web browser, a user may interact with implementations of the systems and techniques described herein through the graphical user interface or the web browser), or any combination of such background components, middleware components, or front-end components. The components of the system may be interconnected by any form or medium of digital data communication (for example, a communication network). Examples of communication networks include a local area network (LAN), a wide area network (WAN), and the Internet.

The computer system may include a client and a server. The client and server are generally remote from each other and typically interact through a communication network. The relationship between the client and the server is generated by computer programs running on the respective computers and having a client-server relationship with each other. The server may be a cloud server, a server of a distributed system, or a server combined with a blockchain.

It should be understood that the various forms of processes shown above may be used to reorder, add or delete steps. For example, the steps described in the present disclosure may be performed in parallel, sequentially, or in a different order, as long as the desired result of the technical solution disclosed in the present disclosure can be implemented, which is not limited herein.

The above specific embodiments do not constitute a limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall fall within the protection scope of the present disclosure.

What is claimed is:

1. A method for virtual fitting, comprising:
obtaining a first person image and a garment image;
performing a masking process of garment information on the first person image to obtain a second person image; and
inputting the second person image and the garment image into a virtual fitting model obtained by pre-training to obtain a virtual fitting image; wherein the virtual fitting model is a dual U-Net structure which comprises an image encoder, two U-Nets, and an image decoder, and the two U-Nets are respectively used as a garment characterization network and a latent diffusion network; wherein the two U-Nets have a same network structure that comprises one or more down-sampling layers, one or more intermediate layers, and one or more up-sampling layers.

2. The method according to claim 1, wherein the inputting the second person image and the garment image into a virtual fitting model obtained by pre-training to obtain a virtual fitting image comprises:
inputting the garment image into the image encoder to obtain a garment latent feature, and taking the garment latent feature as an input of the garment characterization network; recording a feature of the up-sampling layers, the intermediate layers, and the down-sampling layers when performing a spatial self-attention operation;
inputting the second person image into the image encoder to obtain a person latent feature and mask region information, and taking the person latent feature, the mask region information and a random noise obeying Gaussian distribution as an input of the latent diffusion network;
respectively concatenating the feature, recorded by the garment characterization network, of the up-sampling layers, the intermediate layers, and the down-sampling layers when performing the spatial self-attention operation with a feature of the up-sampling layers, the intermediate layers, and the down-sampling layers at a corresponding position of the latent diffusion network when performing the spatial self-attention operation in a process of performing iterative denoising, to obtain a concatenated feature, and taking the concatenated feature as a feature of the latent diffusion network at the corresponding position; and
inputting a feature output by the latent diffusion network into the image decoder to output the virtual fitting image.

3. The method according to claim 1, wherein a training process of the virtual fitting model comprises:
adding a random noise to a training sample in a diffusion step based on Markov chain, recovering a clean sample from a noise sample in a reverse process, calculating a loss between a real noise and an estimated noise, back propagating and updating a model parameter of the latent diffusion network until convergence, saving the model parameter and taking the model parameter as a model parameter of the garment characterization network.

4. The method according to claim 1, wherein the performing a masking process of garment information on the first person image to obtain a second person image comprises:
inputting the first person image into a pre-trained deep learning image semantic segmentation neural network model for semantic segmentation to obtain a semantic segmented person image, wherein the semantic segmented person image at least comprises an image divided into a human body information region and a garment information region; and
performing the mask processing on the garment information region in the semantic segmented person image to obtain the second person image.

5. The method according to claim 4, wherein the performing the mask processing on the garment information region in the semantic segmented person image to obtain the second person image comprises:
obtaining a fitting region of a garment in the garment image and a person in the semantic segmented person image; and taking a union set of the fitting region and the garment information region in the semantic segmented person image as a region that needs to be masked in a person image.

6. The method according to claim 5, wherein the obtaining a fitting region of a garment in the garment image and a person in the semantic segmented person image comprises:
performing a posture recognition on the semantic segmented person image to obtain posture information;
segmenting the garment image to obtain a to-be-masked region of the garment; and
inputting the to-be-masked region and the posture information into a pre-trained shallow convolutional neural network to determine a mask region, in a human body in the semantic segmented person image, of the garment in the garment image, and taking the mask region as a region that needs to be performed mask processing in the person image.

7. A method for virtual fitting, comprising:
obtaining virtual fitting images by using the method for virtual fitting according to claim 1, wherein the first person image comprises a user image, there are at least two garment images, and the virtual fitting images respectively correspond to the garment images; and
selecting at least one target virtual fitting image from at least two virtual fitting images for display or recommendation.

8. An electronic device, comprising:
at least one processor; and
a memory communicatively connected to the at least one processor;
wherein the memory is configured to store executable instructions, when the executable instructions are executed by the at least one processor, a method for virtual fitting is implemented, and the method for virtual fitting comprises:
obtaining a first person image and a garment image;
performing a masking process of garment information on the first person image to obtain a second person image; and
inputting the second person image and the garment image into a virtual fitting model obtained by pre-training to obtain a virtual fitting image; wherein the virtual fitting model is a dual U-Net structure which comprises an image encoder, two U-Nets, and an image decoder, and the two U-Nets are respectively used as a garment characterization network and a latent diffusion network; wherein the two U-Nets have a same network structure that comprises one or more down-sampling layers, one or more intermediate layers, and one or more up-sampling layers.

9. The electronic device according to claim 8, wherein the inputting the second person image and the garment image into a virtual fitting model obtained by pre-training to obtain a virtual fitting image comprises:
inputting the garment image into the image encoder to obtain a garment latent feature, and taking the garment latent feature as an input of the garment characterization network; recording a feature of the up-sampling layers, the intermediate layers, and the down-sampling layers when performing a spatial self-attention operation;
inputting the second person image into the image encoder to obtain a person latent feature and mask region information, and taking the person latent feature, the mask region information and a random noise obeying Gaussian distribution as an input of the latent diffusion network;
respectively concatenating the feature, recorded by the garment characterization network, of the up-sampling layers, the intermediate layers, and the down-sampling layers when performing the spatial self-attention operation with a feature of the up-sampling layers, the intermediate layers, and the down-sampling layers at a corresponding position of the latent diffusion network when performing the spatial self-attention operation in a process of performing iterative denoising, to obtain a concatenated feature, and taking the concatenated feature as a feature of the latent diffusion network at the corresponding position; and
inputting a feature output by the latent diffusion network into the image decoder to output the virtual fitting image.

10. The electronic device according to claim 8, wherein a training process of the virtual fitting model comprises:
adding a random noise to a training sample in a diffusion step based on Markov chain, recovering a clean sample from a noise sample in a reverse process, calculating a loss between a real noise and an estimated noise, back propagating and updating a model parameter of the latent diffusion network until convergence, saving the model parameter and taking the model parameter as a model parameter of the garment characterization network.

11. The electronic device according to claim 8, wherein the performing a masking process of garment information on the first person image to obtain a second person image comprises:
inputting the first person image into a pre-trained deep learning image semantic segmentation neural network model for semantic segmentation to obtain a semantic segmented person image, wherein the semantic segmented person image at least comprises an image divided into a human body information region and a garment information region; and
performing the mask processing on the garment information region in the semantic segmented person image to obtain the second person image.

12. The electronic device according to claim 11, wherein the performing the mask processing on the garment information region in the semantic segmented person image to obtain the second person image comprises:
obtaining a fitting region of a garment in the garment image and a person in the semantic segmented person image; and taking a union set of the fitting region and the garment information region in the semantic segmented person image as a region that needs to be masked in a person image.

13. The electronic device according to claim 12, wherein the obtaining a fitting region of a garment in the garment image and a person in the semantic segmented person image comprises:
performing a posture recognition on the semantic segmented person image to obtain posture information;
segmenting the garment image to obtain a to-be-masked region of the garment; and
inputting the to-be-masked region and the posture information into a pre-trained shallow convolutional neural network to determine a mask region, in a human body in the semantic segmented person image, of the garment in the garment image, and taking the mask region as a region that needs to be performed mask processing in the person image.

14. An electronic device, comprising:
at least one processor; and
a memory communicatively connected to the at least one processor; wherein,
wherein the memory is configured to store executable instructions, when the executable instructions are executed by the at least one processor, the method for virtual fitting according to claim 7 is implemented.

15. A non-transitory computer-readable storage medium storing computer instructions, wherein the computer instructions are configured to enable a computer to perform a method for virtual fitting, the method comprises:
obtaining a first person image and a garment image;
performing a masking process of garment information on the first person image to obtain a second person image; and
inputting the second person image and the garment image into a virtual fitting model obtained by pre-training to obtain a virtual fitting image; wherein the virtual fitting model is a dual U-Net structure which comprises an image encoder, two U-Nets, and an image decoder, and the two U-Nets are respectively used as a garment characterization network and a latent diffusion network; wherein the two U-Nets have a same network structure that comprises one or more down-sampling layers, one or more intermediate layers, and one or more up-sampling layers.

16. The storage medium according to claim 15, wherein the inputting the second person image and the garment image into a virtual fitting model obtained by pre-training to obtain a virtual fitting image comprises:
inputting the garment image into the image encoder to obtain a garment latent feature, and taking the garment latent feature as an input of the garment characterization network; recording a feature of the up-sampling layers, the intermediate layers, and the down-sampling layers when performing a spatial self-attention operation;
inputting the second person image into the image encoder to obtain a person latent feature and mask region information, and taking the person latent feature, the mask region information and a random noise obeying Gaussian distribution as an input of the latent diffusion network;
respectively concatenating the feature, recorded by the garment characterization network, of the up-sampling layers, the intermediate layers, and the down-sampling layers when performing the spatial self-attention operation with a feature of the up-sampling layers, the intermediate layers, and the down-sampling layers at a corresponding position of the latent diffusion network when performing the spatial self-attention operation in a process of performing iterative denoising, to obtain a concatenated feature, and taking the concatenated feature as a feature of the latent diffusion network at the corresponding position; and
inputting a feature output by the latent diffusion network into the image decoder to output the virtual fitting image.

17. The storage medium according to claim 15, wherein a training process of the virtual fitting model comprises:
adding a random noise to a training sample in a diffusion step based on Markov chain, recovering a clean sample from a noise sample in a reverse process, calculating a loss between a real noise and an estimated noise, back propagating and updating a model parameter of the latent diffusion network until convergence, saving the model parameter and taking the model parameter as a model parameter of the garment characterization network.

18. The storage medium according to claim 15, wherein the performing a masking process of garment information on the first person image to obtain a second person image comprises:
inputting the first person image into a pre-trained deep learning image semantic segmentation neural network model for semantic segmentation to obtain a semantic segmented person image, wherein the semantic segmented person image at least comprises an image divided into a human body information region and a garment information region; and
performing the mask processing on the garment information region in the semantic segmented person image to obtain the second person image.

19. The storage medium according to claim 18, wherein the performing the mask processing on the garment information region in the semantic segmented person image to obtain the second person image comprises:
obtaining a fitting region of a garment in the garment image and a person in the semantic segmented person image; and taking a union set of the fitting region and the garment information region in the semantic segmented person image as a region that needs to be masked in a person image.

20. A non-transitory computer-readable storage medium storing computer instructions, wherein the computer instructions are configured to enable a computer to perform the method for virtual fitting according to claim 7.
